(19) United States
(12) Patent Application Publication
(10) Pub. No.: US 2026/0236388 A1
(43) Pub. Date: Aug. 13, 2026

(54) AUTOMATIC MANAGEMENT OF IN-PROGRESS VOLUME DRAINING

(71) Applicant: INTERNATIONAL BUSINESS MACHINES CORPORATION, ARMONK, NY (US)

(72) Inventors: ANTHONY TUDOROV, RED BANK, NJ (US); WALTER CHURCH, IV, SCOTCH PLAINS, NJ (US); KEVIN SCOTT ADAMS, ENDICOTT, NY (US)

(21) Appl. No.: 19/049,276

(22) Filed: Feb. 10, 2025

(51) Int. Cl. G06F 12/02; G06F 3/06

(52) U.S. Cl. CPC G06F 12/023; G06F 3/0652

(57) ABSTRACT

Automatic management of in-progress volume draining includes identifying a source page volume for draining to one or more target page volumes and predicting whether at least one target page volume will exceed a utilization threshold as a result of draining page data from the source page volume to the one or more target page volumes. automatic management of in-progress volume draining also includes generating an alert in response to predicting that the utilization threshold will be exceeded. In some aspects, when utilization threshold is predicted to be exceeded, the draining of the source page volume is abandoned and prevented from being taken offline.

### BACKGROUND

The present disclosure relates to methods, apparatus, and products for automatic management of in-progress volume draining. In a computing system, pages of data are paged in and out of main memory to achieve virtualization of main memory. This page data is paged to a page space including one or more physical page volumes. To replace or perform maintenance on a page volume, the page volume must be brought offline, which requires draining the page data from the page volume to ensure that no data is lost. By taking the page volume offline and draining the page data, the overall page space is reduced. This reduction in the page space capacity can lead to an exhaustion of memory resources and/or competition for memory resources among processes executing on the computer system.

### SUMMARY

According to embodiments of the present disclosure, various methods, apparatus and products for automatic management of in-progress volume draining are described herein. In some aspects, automatic management of in-progress volume draining includes identifying a source page volume for draining to one or more target page volumes, predicting whether at least one target page volume will exceed a utilization threshold as a result of draining page data from the source page volume to the one or more target page volumes, and generating an alert in response to predicting that the utilization threshold will be exceeded. In some aspects, when it is predicted that the utilization threshold will be exceeded, the source page volume is preserved, e.g., by preventing the page volume from draining and being taken offline. Thus, the source page volume remains active and contributes to the available page space. In other aspects, the draining of the page volume is allowed to continue. In these cases, a capacity utilization of the one or more target page volumes is monitored during the draining. It is determined whether a capacity utilization of the one or more target page volumes has exceeded second threshold that is lower than the utilization threshold, and whether standby memory is available in response to determining that the capacity utilization has exceeded the second threshold. If standby memory is available, system memory space is reconfigured to include additional memory space from the standby memory. In some aspects, if standby memory is not available or runs out, it is determined whether a capacity utilization of the one or more target page volumes has exceeded the utilization threshold. If so, a page volume is selected for restarting, e.g., by returning the page volume to an active state. The restarted page volume can then be used for paging data out of the system memory space.

### BRIEF DESCRIPTION OF THE DRAWINGS

FIG. 1 sets forth an example environment for automatic management of in-progress volume draining in accordance with at least one embodiment of the present disclosure.

FIG. 2A sets forth an example state of a system environment consistent with at least one embodiment of the present disclosure.

FIG. 2B sets forth another example state of the system environment of FIG. 2A.

FIG. 2C sets forth another example state of the system environment of FIG. 2B.

FIG. 3 sets forth another example state of a system environment consistent with at least one embodiment of the present disclosure.

FIG. 4 sets forth another example state of a system environment consistent with at least one embodiment of the present disclosure.

FIG. 5 sets forth a flow chart of an example method of automatic management of in-progress volume draining in accordance with at least one embodiment of the present disclosure.

FIG. 6 sets forth a flow chart of an example method of automatic management of in-progress volume draining in accordance with at least one embodiment of the present disclosure.

FIG. 7 sets forth a flow chart of an example method of automatic management of in-progress volume draining in accordance with at least one embodiment of the present disclosure.

FIG. 8 sets forth a flow chart of an example method of automatic management of in-progress volume draining in accordance with at least one embodiment of the present disclosure.

FIG. 9 sets forth a flow chart of an example method of automatic management of in-progress volume draining in accordance with at least one embodiment of the present disclosure.

FIG. 10 sets forth an example computing system environment for automatic management of in-progress volume draining in accordance with at least one embodiment of the present disclosure.

### DETAILED DESCRIPTION

Computer systems often support partitioning, a feature primarily utilized in server systems to divide system resources into logically partitioned groups. This process involves organizing memory devices, processors, and input/output (I/O) devices into independent, secure resource groups. Each partition supports virtual machines (VMs) that typically run their own independent operating system (OS) image, enabling multiple OS instances to execute concurrently on a single computer system. This setup allows each VM to operate independently of others on the same system. A guest user, or tenant, of the computer system is allocated one of these partitions to support the tenant’s VMs and processes executed on those VMSs. The partitioning and assignment of resources in the computer system may be performed by a resource manager, such as a hypervisor.

As part of the partitioning, a tenant is allocated a portion of the physical memory in the system, or ‘main memory.’ This allocated physical system memory is used to back a virtual address space that is larger than the allocated physical address space and may be managed by a memory management controller of the resource manager. To achieve the virtualization of physical memory, the memory management controller transfers pages of physical memory to secondary storage in order to meet the demands on the system. ‘Paging’ allows for efficient use of limited physical memory by temporarily offloading less critical memory pages. The transfer of the contents of a page of physical memory to secondary storage is referred to as ‘paging out.’ The transfer of a page from secondary storage into physical memory is referred to as ‘paging in.’ For example, if a page in physical memory has not been accessed or modified recently, then that page may be eligible for paging out to secondary storage.

The secondary storage used for paging is a page volume and the collection of page volumes is referred to a page space. A page volume is non-volatile storage, such as a hard disk, SSD, or other direct access storage device, that is dedicated to storing pages offload from physical memory, thus providing backing storage for the virtual address space. In some examples, although not a requirement, page volumes are kept separate from other volumes used to store data in the system, thus ensuring availability for critical paging operations. Typically, the number of page volumes allocated to the tenant is selectable by the tenant. The memory management controller moves memory pages between physical memory and the page volume as needed, depending on memory access patterns and system workload. Since accessing data from page volumes is slower than accessing data in physical memory, excessive reliance on paging can lead to performance degradation, commonly referred to as thrashing. Thus, page volumes must have sufficient capacity to handle the memory overflow while maintaining system stability and performance. In some cases, for management of storage within a page volume, page volumes are partitioned into ‘slots,’ which is the smallest unit of storage within a page volume. By way of illustration, a 20GB page volume may be divided into 4KB slots.

In some implementations, when a page in the page volume has been paged into physical memory, the storage occupied by the page in the page volume is released and can then be reused for paging operations. In other implementations, the storage space occupied by a page is not released when that page is paged into physical memory. In these implementations, the page volume space used by a process may be held open for that process until the process terminates. This feature may be a parameter of the system, referred to herein as ‘keep-slot.’ When keep-slot is on, pages are retained both in the page volume and in physical memory. Although this feature may lead to a high storage consumption in the page volumes, it conserves I/O bandwidth when a page is unmodified in physical memory and thus does not have to be written back to the page volume.

In some cases, it may be desirable to remove a page volume as storage used to back the tenant’s virtual address space. For example, the page volume may be leased by the tenant. As such, there may be some cost saving in releasing the page volume if it is not needed. The page volume can then be reallocated to a different tenant. In other cases, the page volume may be removed from the system as part of an upgrade. In any of these cases, to avoid data loss, the data in the page volume must be transferred off the page volume to either physical memory or another page volume. The transfer and permanent removal of data from a page volume is referred to as ‘draining.’ The page volume may be drained to physical memory, in that all data in the page volume is transferred to physical memory. This data can then be retained in physical memory or transferred to another page volume. Thus, to drain a page volume to another page volume, that data must pass through physical memory.

As discussed above, as new page volumes are brought online to the system to replace old page volumes, the old volumes cannot be removed until they are empty. This prevents the loss of guest or system information that may have been paged out. The active draining process of moving volume contents naturally increases the paging activity on other page volumes. During active drain, the amount of available page space may be filled up by the draining volumes’ pages. This can be caused by normal paging operations happening on the system exacerbated by the reduced page space from draining volume(s) whose contents also now have to fill up system memory or other paging space. Also, as draining occurs, changes in paging rates due to system processes and tenant activity, for example, could impact the available capacity of active page volumes and/or physical memory. For example, tenants have a spike in their workload while an active drain is occurring – this would cause more memory to be used and make less space available which could lead to page space filling up even faster. The speed of the system moving pages off draining volumes that will be removed and placed into available space can happen without the system operator realizing until the page space is nearly full. At that point, it may already be too late for the system operator to attempt to stop the active drain. Further, although the draining may have stopped automatically, paging is still occurring and the volumes marked for draining cannot be used unless restarted as page volumes.

In accordance with the present disclosure, systems, methods, apparatuses, and computer program products are provided to determine whether page space utilization exceeds available resources and automatically prevents the draining of a page volume when such activity would exceed the threshold. Further, if approaching the threshold, embodiments provide for automatically allocating additional memory to accommodate the additional page space needed by the draining. If the additional memory is insufficient to avoid resource overutilization, embodiments provide a selection mechanism to automatically determine which actively draining volume should be restarted as an active page volume.

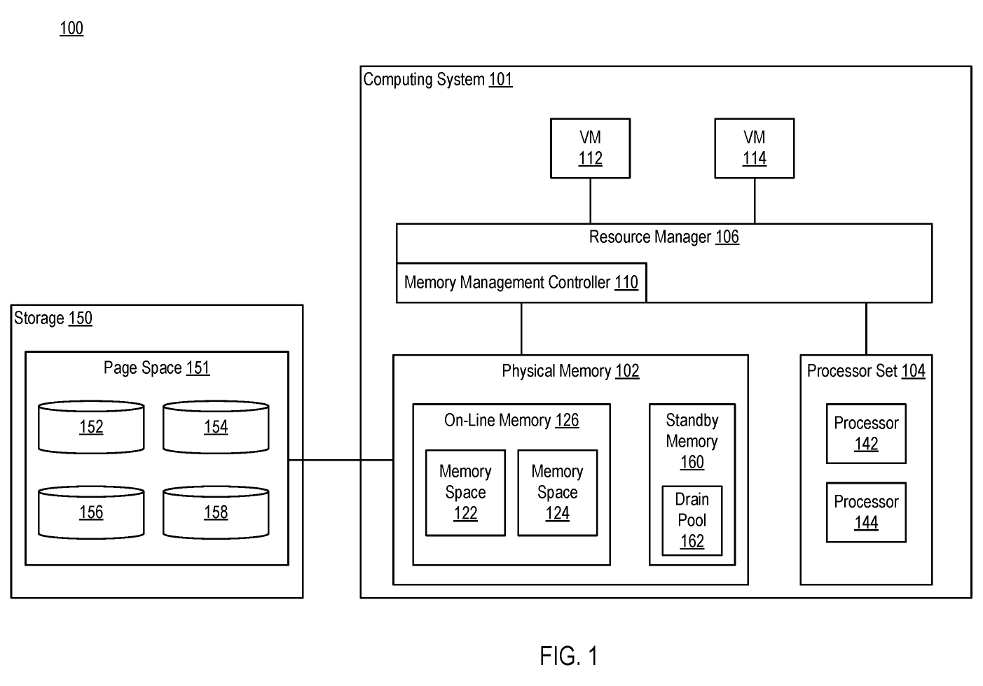

For further explanation, FIG. 1 sets forth an example environment 100 for automatic management of in-progress volume draining in accordance with at least one embodiment of the present disclosure. Environment 100 includes a computing system 101 having a physical memory 102 and a processor set 104. Computing system 101 also includes a resource manager 106, such as a hypervisor, that allocates physical resources such as memory resources of physical memory 102 (e.g., volatile random access memory (RAM)) and processing resources of processor set 104, to VMs 112, 114 that are hosted on environment 100. In the example of FIG. 1, physical memory 102 includes two or more memory spaces 122, 124; for example, memory space 122 may be allocated to VM 112 by resource manager 106, while memory space 124 may be allocated to VM 114 by resource manager 106. Physical memory 102 is addressable via a physical memory address space. Environment 100 also includes a processor set 104 that includes two or more processors 142, 144. For example, processor 142 may be allocated to VM 112 by the resource manager, while processor 144 may be allocated to VM 114 by resource manager 106. Although two VMs are shown in FIG. 1, it will be appreciated that environment 100 can host any number of VMs. In various implementations, resource manager 106 is implemented by computer software, firmware, and/or hardware, and can create and run VMs 112, 114. The resource manager 106 forms logical partitions (LPARs) from the physical resources that make up partitioned hardware. The term LPAR and VM may be used interchangeably.

Resource manager 106 is typically allocated an amount of on-line memory 126 from physical memory 102, which resource manager 106 then assigns to VMs 112, 114 hosted on computing system 101. Typically, the address space allocated to a VM exceeds the physical memory that supports the allocated memory, also referred to a ‘virtual memory.’ That is, the virtual address space allocated to a VM exceeds the physical address space that is used to support the physical address space. Thus, at any given time, the amount of memory allocated in computing system 101 may exceed the amount of physical memory 102 in the system. Further, at least a portion of the memory (e.g., reconfigurable memory increments) can be added and removed from each VM 112, 114 dynamically while the system is running from standby memory 160. Resource manager 106 includes a memory management controller 110 that pages data in and out of physical memory, as described above, to support the virtual memory that is allocated to each VM 112, 114.

Environment 100 also includes storage 150, which may be implemented as a set of storage elements such as hard disks, SSDs, non-volatile RAM, and the like. The storage elements composing storage 150 may be collocated in the same chassis or remotely disposed separate servers. Storage 150 supports multiple paging volumes 152, 154, 156, 158 included in a page space 151 that acts as secondary storage for physical memory 102. Memory management controller 110 pages data in and out of physical memory 102 to a page space comprised of page volumes 152, 154, 156, 158. In some examples, as with the other hardware resources in environment 100, paging volumes 152, 154, 156, 158 may be partitioned across VMs 112, 114 and managed by resource manager 106. In other examples, storage 150 and paging volumes 152, 154, 156, 158 may be separately managed. Memory management controller 110 may apply page eviction policies to determine when a particular page of data in physical memory 102 should be paged out to a paging volume. For example, when a page has not been modified or accessed within a threshold amount of time), memory management controller 110 may cause a page of data in physical memory 102 to be transferred to a paging volume. As the number of processes increases or memory demand increases due to VM activity, the policies for determining how frequently data should be paged out may change, thus causing data to paged out to a paging volume at a faster rate to meet memory demand.

Memory management controller 110 also administers the draining of page volumes 152, 154, 156, 158. For example, if page volumes 156, 158 are removed from environment 100 or deallocated from a particular VM, page volumes 156, 158 may be drained to page volumes 152, 154. For example, resource manager 106 may receive a command or request to drain volumes 156, 158, thus causing those page volumes to be added to a list of page volumes to be drained or otherwise marked for draining. As part of the draining, data in page volumes 156, 158 would be transferred to physical memory 102 and then paged out to page volumes 152, 154. In this process, page volumes 156, 158 are marked for draining by the system, and could no longer be used for paging (i.e., they are removed from the page space). To ensure that enough space remains available on page volumes 152, 154 to complete the drain, particularly in view of a potential spike in paging activity, the memory management controller 110 consistent with embodiments of the present disclosure provides a drain protection feature. When the drain protection feature is enabled, memory management controller 110 predicts whether the draining of a page volume will cause a page space utilization threshold to be exceeded. The page space utilization threshold may be a tunable system parameter that is set to ensure that an overcommitment of physical memory is not made. In illustrative non-limiting example, an example page space utilization threshold may be 90%. In some examples, the page space utilization is determined for the page space comprising all of the page volumes. Thus, with drain protection enabled, a page volume drain should not result in any other page volume exceeding the page space utilization threshold.

In some examples, to predict whether a page volume drain will cause the page space utilization to exceed a threshold, the memory management controller 110 identifies the total number of slots in the page space. The total number of slots is the page space capacity (e.g., 80 GB total across four page volumes) divided by the slot size (e.g., 4KB). Resource manager 106 determines the total number of slots that are in use, including the in-use slots that are in the page volume to be drained. A slot is in-use if, for example, the data in that slot is being used by a running process and thus could be paged back into physical memory. A slot is not in-use if the slot has been marked for overwriting, the process that owned the data in the slot is no longer running, a threshold amount of time has elapsed since the data has been accessed, and so on. To predict the page space utilization, the total number of slots in-use (including slots to be drained) is divided by a subtraction of the number of slots to be drained from the total number of slots in the page space. That is, the predicted page space utilization = total number of slots in use / (total number of slots – the number of slots to be drained). If the predicted page space utilization is greater than the page space utilization limit, as set via tunable parameter, the resource manager 106 does not allow the page volume to be drained when the drain protection feature is enabled. It will be appreciated that the number of slots in-use is a dynamic factor that can change based on the paging intensity of the environment 100.

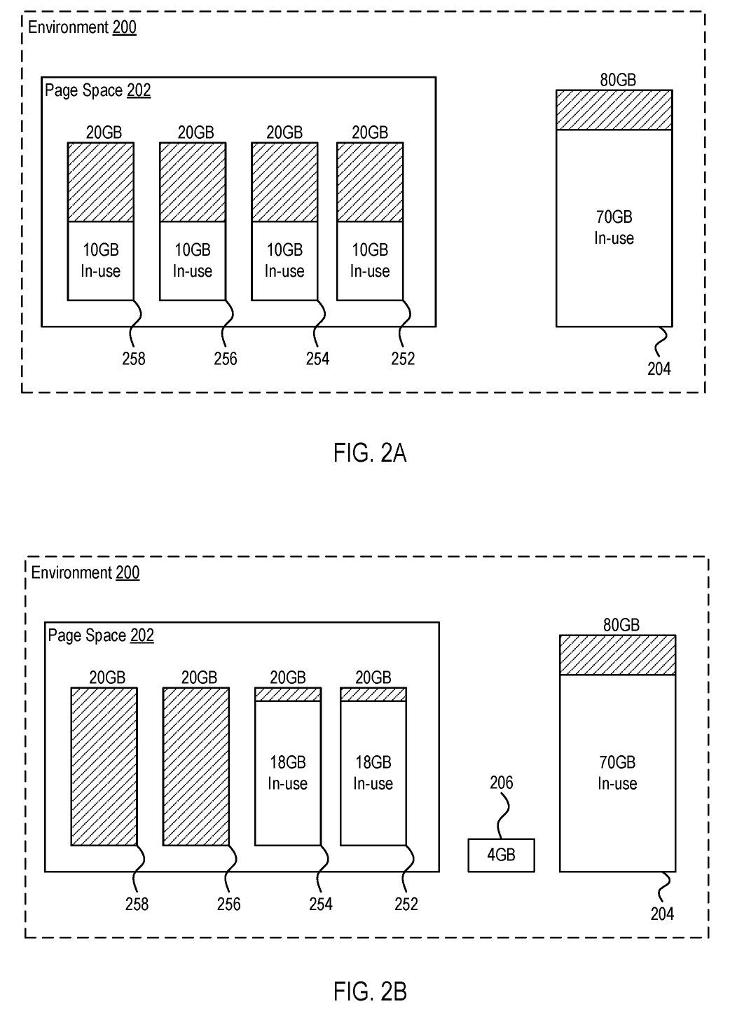

For further explanation FIG. 2A illustrates an example system environment 200, which may be similar to the environment 100 of FIG. 1. Environment 200 includes a page space 202 that includes page volumes 252, 254, 256, 258 and also a physical memory space 204 that includes physical memory that has been allocated to the tenant. As can be seen in FIG. 2A, each of the page volumes 252, 254, 256, 258 has a capacity of 20GB. Each of the page volumes 252, 254, 256, 258 has a current capacity utilization of 50% in that 10GB of each page volume 252, 254, 256, 258 is currently in-use by holding page data of running processes that has been paged out of the physical memory space 204. In this example, for the purpose of illustration, the capacity utilization threshold for each volume is set to 90% (which can be adjusted by the operator) to ensure that the page volumes can handle spikes in paging activity. In the example of FIG. 2A, the utilization of the physical memory space is 70GB out of 80 GB.

For further explanation, FIG. 2B illustrates a hypothetical scenario for system environment 200 in which page volumes 256, 258 are selected for draining. As can be seen in FIG. 2B, page volumes 252, 254 can only accommodate 8GB each to avoid exceeding the 90% capacity utilization threshold, leaving 4GB of excess data 206. With the drain protection feature enabled, the draining of page volumes 256, 258 would not be carried out. At least one of the page volumes would be preserved as an active page volume.

If the drain protection feature is not enabled, or if a user overrides the drain protection feature and moves forward with the page volume drain, the data that cannot be drained to other page volumes could potentially be held in physical memory at least temporarily. FIG. 2C illustrates a hypothetical scenario for system environment 200 in which, because there is room in the physical memory space to accommodate the excess data 206, the excess data 206 is held in the physical memory space 204 at least temporarily to allow the page volumes 256, 258 to complete their draining. The excess data 206 can be paged out when paging activity decreases (e.g., processes terminate normally) or when new page volumes are brought online (e.g., where page volumes 256, 258 are being replaced with new page volumes).

However, in some cases storing the data in physical memory could exhaust the physical memory space and cause environment 100 to abnormally end processes. For example, storing the excess data 206 in physical memory could cause physical memory to exceed a physical memory utilization limit that is meant to avoid abnormally ending programs due to a lack of available physical memory. To avoid the exhaustion of physical memory or exceeding a physical memory utilization limit, in some examples resource manager 106 reacts by configuring additional physical memory to accommodate the data of the drained volumes.

Returning to FIG. 1, in some examples, resource manager 106 allocates a pool of memory, referred to herein as a ‘drain pool’ 162, from standby memory 160 in system 500. Memory from the drain pool 162 can be added in increments to the physical memory to accommodate the paged in excess data 206 that cannot be immediately drained to another page volume. This additional memory can be dynamically configured as reconfigurable memory that is later released when no longer needed. In some examples, the memory from the drain pool 162 is added to the total available slots in page space for recalculating the page space utilization in view of the additional memory available.

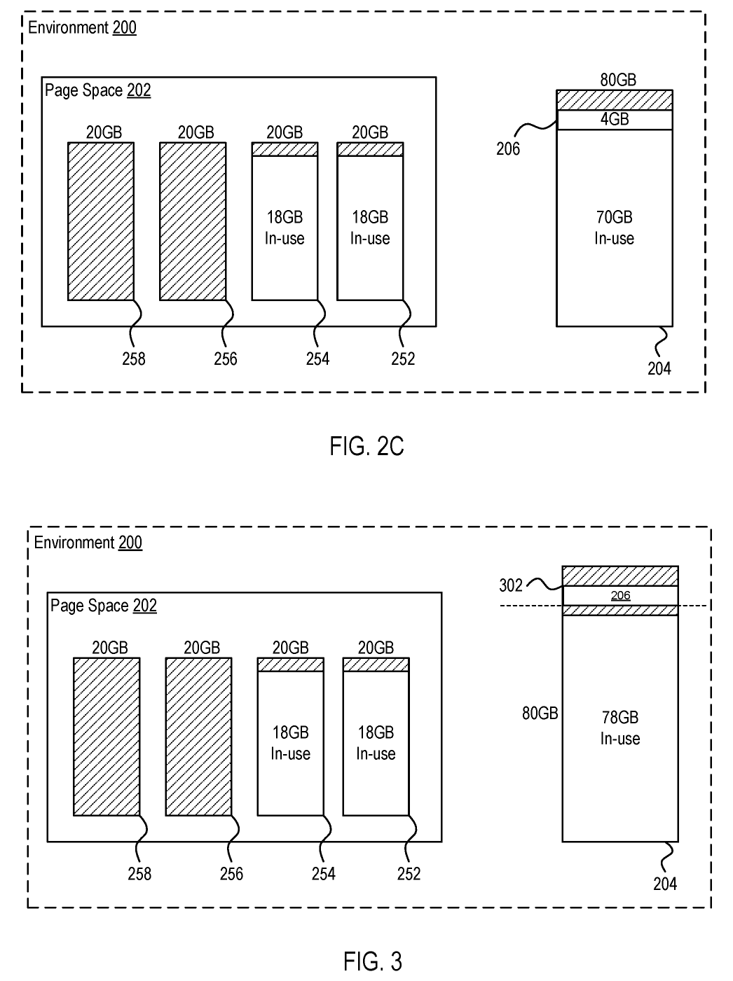

For further explanation, FIG. 3 sets forth an example a hypothetical scenario for system environment 200 in which the 78GB of system memory space 204 is being utilized and thus cannot accommodate the 4GB of excess data 206. In this example, system memory space 204 is reconfigured with additional physical memory space 302 that is allocated from the drain pool in standby memory 160. The excess data 206 from FIG. 2B is stored in this additional memory space 302. If the page space utilization limit is still exceeded with the additional drain pool memory, the resource manager 106 may react by restarting page volumes to recapture page space.

In some examples, when adding memory from drain pool 162 will not alleviate the memory pressure caused by the draining page volumes, the resource manager 106 determines which page volume to restart so that data can be paged back to the restarted page volume. If page space exceeds the page space utilization limit one or more draining page volumes will be restarted for normal paging operation. In some implementations, page volumes will be chosen and restarted until one of the following conditions is met: 1) page space is under the page space utilization limit or 2) there are no more draining page volumes. The resource manager 106 will select the best page volume for restart, where ‘best’ means the page volume that, after it is restarted, will allow the greatest number of draining volumes to finish draining.

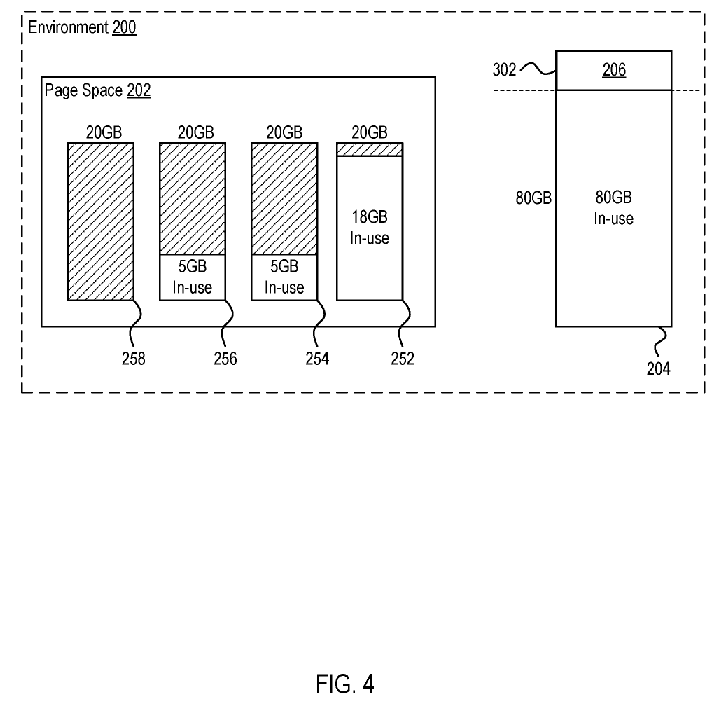

In cases where the keep-slot parameter is not enabled, and space is freed upon draining or partially draining data from a page volume, the resource manager 106 may select the drained or partially drained page volume with the most available slots as the page volume to restart. For further explanation, FIG. 4 illustrates that page volumes 254, 256, 258 were selected for draining. Page volume 258 was completely drained and page volume 256 and page volume 254 were halfway drained. All drain pool memory available for allocation has been allocated and used. In this example, the resource manager 106 will select page volume 258 to restart. Data that was paged into physical memory and drain pool memory is then paged out to page volume 258. Page volume 254 and page volume 256 are then permitted to continue draining.

In cases where the keep-slot parameter is enabled, and pages that are paged back into physical memory are not discarded in the page volume, the page volume with the highest score is selected. The score is based on a weight multiplied by total in-use space on the volume plus the total not in-use space on the volume. The weight is a value from 0 to 1 based on a percentage of in-use space that will need new slots due to those pages not already having a physical slot in memory. When the keep-slot feature is enabled, when a page has been previously paged in, its slot is retained in the page volume. When a volume with in-use slots is drained and moved to physical memory, the resource manager will find that a) a given page will already resident in physical memory and does not require a new slot on another volume or b) that page is not resident in physical memory and will likely have to paged out again, thus requiring a new slot in the page volumes. Thus, the weight can be determined by monitoring activity in the physical memory address space and/or predicting that a particular page is already in physical memory or will need to be paged back out, thus requiring a new slot. As the weight approaches zero, there is a higher likelihood that a new slot will be required.

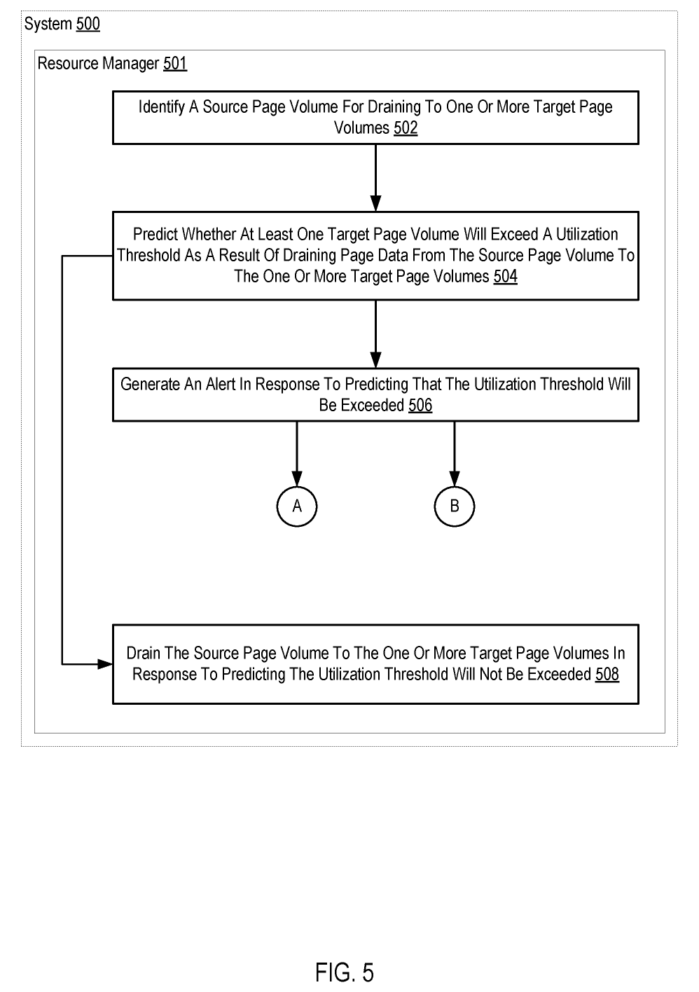

For further explanation, FIG. 5 sets forth a flow chart illustrating an example method of automatic management of in-progress volume draining in accordance with at least one embodiment of the present disclosure. The example of FIG. 5 includes a resource manager 501 of a system 500. For example, the resource manager may implement resource manager 106 described above. The system 500 may implement a system like environment 100, in which multiple tenants are hosted on the system 500. Hardware resources of the system are partitioned among these tenants. Specifically, hardware resources are partitioned across multiple virtual machines running on the system.

The method of FIG. 5 includes identifying 502 a source page volume for draining to one or more target page volumes. In some examples, the resource manager identifies 502 a source page volume for draining to one or more target page volumes from a list of page volumes to be drained. For example, the list may be implemented as a data structure that describes page volumes utilized by the system 500. In some examples, a flag may be set in relation to a page volume indicating that the page volume is to be drained. When a page volume is marked for draining, that page volume becomes a source of page data to be transferred to another location. As such, a page volume to be drained is a source page volume. In some examples, page volumes are added to the list in response to a command or request from a user to drain the page volume. That user may be, for example, a system administrator or operator of system 500 or other technician. When the command to drain a page volume is received through an interface (e.g., a command line), the page volume may be added to the list of page volumes to be drained. In some implementations, draining a source page volume to a target page volume includes transferring page data from the source page volume into a memory space of system memory and then transferring the same page data to the target page volume.

The method of FIG. 5 also includes predicting 504 whether at least one target page volume will exceed a utilization threshold as a result of draining page data from the source page volume to the one or more target page volumes. In some examples, resource manager 501 accesses a tunable parameter indicating a capacity utilization threshold for page volumes in the system. This parameter may be set by a user such as a system administrator. The utilization threshold is a storage capacity utilization metric. For example, the utilization threshold may be 90%, reflecting that 90% of the storage capacity of the page volume is in use. In some examples, resource manager predicts 504 whether at least one target page volume will exceed the utilization threshold as a result of the draining by determining the total number of slots that are in use among all page volumes to be drained, including the in-use slots that are to be drained. In some examples, the total number of slots in use and number of slots to be drained are determined for the entire page space, i.e., all active page volumes allocated to the tenant. The total number of slots in-use (including slots to be drained) is divided by a subtraction of the number of slots to be drained from the total number of slots in the page space. That is, the predicted page space utilization = total number of slots in use / (total number of slots – the number of slots to be drained).

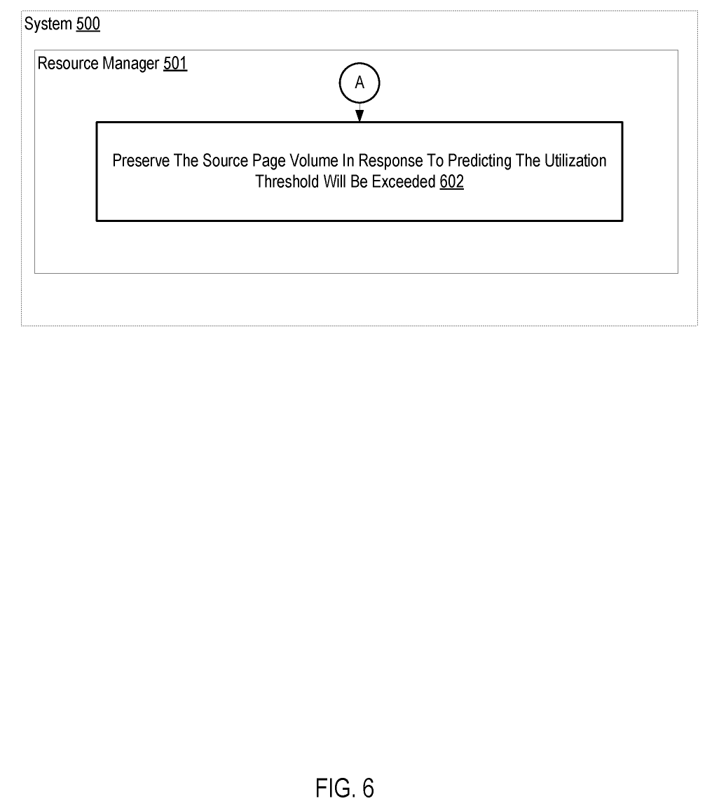

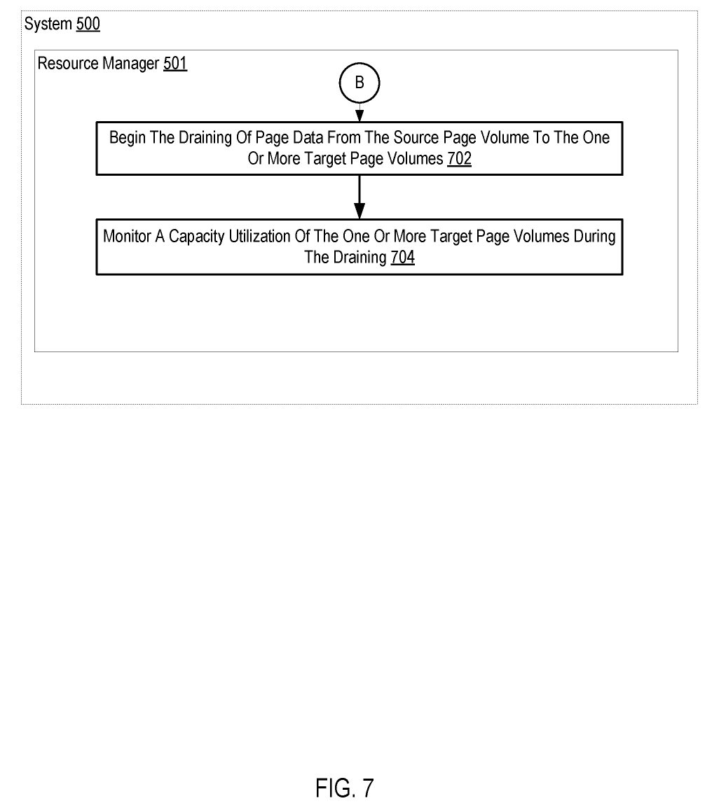

The method of FIG. 5 also includes generating 506 an alert in response to predicting that the utilization threshold will be exceeded. When the predicted capacity utilization of any target volume as a result of the planned page volume drain exceeds the utilization threshold, the resource manager 501 generates 506 the alert. Generating the alert can include issuing a command line statement, generating a notification in a graphical user interface, writing data to a log file, and so on. In some examples, the user can opt to continue with the draining of the page volume even though the alert is generated. For example, the user may remove other page volumes from the list of page volumes to be drained before proceeding with the draining of source page volumes. In some implementations, the flow may progress to path A as shown in FIG. 6 when a drain protection feature is enabled to prevent the resource manager 501 from draining the page volume when the utilization threshold exceeded. In some implementations, the flow may progress to path B shown in FIG. 7 when no drain protection feature is enabled and the resource manager 501 continues with the draining of the source page volume.

The method of FIG. 5 also includes draining 508 the source page volume to the one or more target page volumes in response to predicting the utilization threshold will not be exceeded. When the predicted capacity utilization of any target volume as a result of the planned page volume drain exceeds the utilization threshold, the resource manager 501 generates 506 the alert, the draining 508 of the source page volume proceeds as planned.

For further explanation, FIG. 6 sets forth another example method of automatic management of in-progress volume draining in accordance with one or more embodiments of the present disclosure. The method of FIG. 6 extends the method of FIG. 5 in that the method of FIG. 6 also includes preserving 602 the source page volume in response to predicting the utilization threshold will be exceeded. In some implementations, as discussed above, system 500 may include a drain protection feature to prevent a page volume from being drained when it is predicted that the page space utilization threshold will be exceeded. In some examples, the resource manager 501 preserves the source page volume in response to predicting the utilization threshold will be exceeded by detecting that the drain protection feature is enabled and not draining the source page volume. For example, the resource manager 501 may bypass a command to drain the source volume, remove the source page volume from the list of page volumes to be drained drain, and/or reset a flag that marks the source page volume for draining. In preserving 602 the source page volume, no page data is deleted from the page volume or marked for overwriting, and the source page volume remains active for the paging space, i.e., capacity of the source page volume can still be used to page data out of system memory.

For further explanation, FIG. 7 sets forth another example method of automatic management of in-progress volume draining in accordance with one or more embodiments of the present disclosure. The method of FIG. 7 extends the method of FIG. 5 in that the method of FIG. 7 also includes beginning 702 the draining of page data from the source page volume to the one or more target page volumes. In some implementations, as discussed above, system 500 may not include a drain protection feature or such a feature may be disabled. In such instances, the resource manager 501 continues with the drain of one or more source page volumes despite the prediction that the utilization threshold will be exceeded. The resource manager 501 drains 602 the page data by transferring the page data to system memory and transferring the same page data to one or more targe page volumes.

The method of FIG. 7 also includes monitoring 704 actual utilization of the page space during the draining. In some examples, the resource manager 501 monitors 704 the capacity utilization during the draining by reading the capacity utilization of the one or more target page volumes as data is transferred into the target page volumes. Monitoring 704 the capacity utilization may include comparing the capacity utilization to the utilization threshold as well as other thresholds that may be used to determine when the actual capacity utilization is considered to be approaching the utilization threshold.

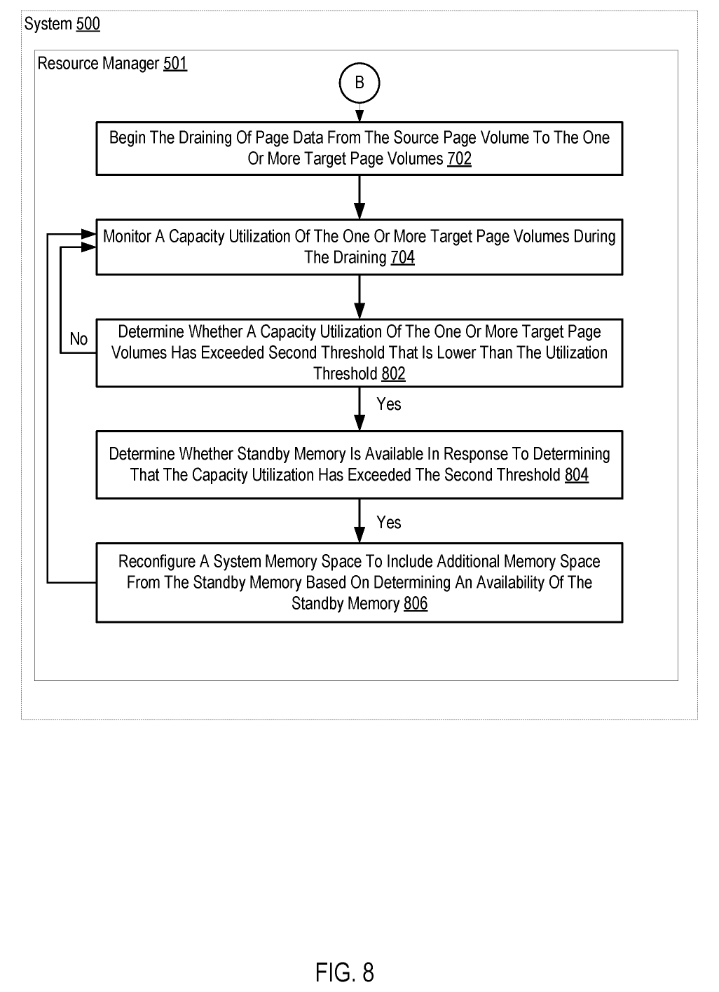

For further explanation, FIG. 8 sets forth another example method of automatic management of in-progress volume draining in accordance with one or more embodiments of the present disclosure. The method of FIG. 8 extends the method of FIG. 7 in that the method of FIG. 8 also includes determining 802 whether a capacity utilization of the one or more target page volumes has exceeded a second threshold that is lower than the utilization threshold. While transferring the page data, the resource manager monitors the capacity utilization of the page space and compares the capacity utilization to a second threshold that is lower than the utilization threshold. The second threshold, which may be considered a warning threshold, indicates that the capacity utilization of the paging space is approaching the utilization threshold. The resource manager determines 802 whether the second threshold indicating the capacity utilization threshold is approaching the utilization threshold has been exceeded after transferring a particular amount of data (e.g., after every page of data transferred). If the capacity utilization is below the second threshold, no immediate action is taken as the capacity utilization is not considered to be approaching the utilization threshold, and the resource manager 501 continues to monitor 704 the capacity utilization of the page space.

The method of FIG. 8 also includes determining 804 whether standby memory is available in response to determining that the capacity utilization has exceeded the second threshold. In some implementations, as discussed above, system 500 may include standby memory that can be temporarily assigned to the tenant. This standby memory can include a pool of memory (e.g., a drain pool) that is used to increase the size of the tenant’s memory space to accommodate page volume draining operations. In these implementations, when the resource manager 501 determines that the page space is approaching the utilization threshold (i.e., the capacity utilization is above the second threshold), the resource manager 501 determines whether memory is available in this pool of memory.

The method of FIG. 8 also includes reconfiguring 806 a system memory space to include additional memory space from the standby memory based on determining an availability of the standby memory. In some examples, if memory is available in the pool of memory, the resource manager 501 reconfigures 806 the system memory space to include additional memory space from the standby memory by allocating the additional memory space to the tenant’s system memory. This reconfiguration of the system memory space can be carried out dynamically while the tenant’s processes are still executing. The additional memory space is allocated temporarily and then released back to the pool of standby memory when no longer needed. In some implementations, the system memory space is reconfigured with incremental amounts of the additional memory. After an increment of additional memory is added, resource manager 501 monitors the page space capacity utilization to determine whether the page space is still approaching the utilization threshold. If so, still more additional memory can be added. In some implementations, each time the system memory space is reconfigured to include an increment of the additional memory, the resource manager 501 may increase the second threshold, moving the threshold closer to the utilization threshold. This compensates the utilization threshold for the additional memory that can be used to buffer drained page data in the system memory space. In some implementations, at least a portion of the page data drained from the source page volume is retained in the system memory space until the capacity utilization is below the second threshold, i.e., no longer approaching the utilization threshold. For example, as workload demands are reduced and less data is paged out, the capacity utilization may decrease.

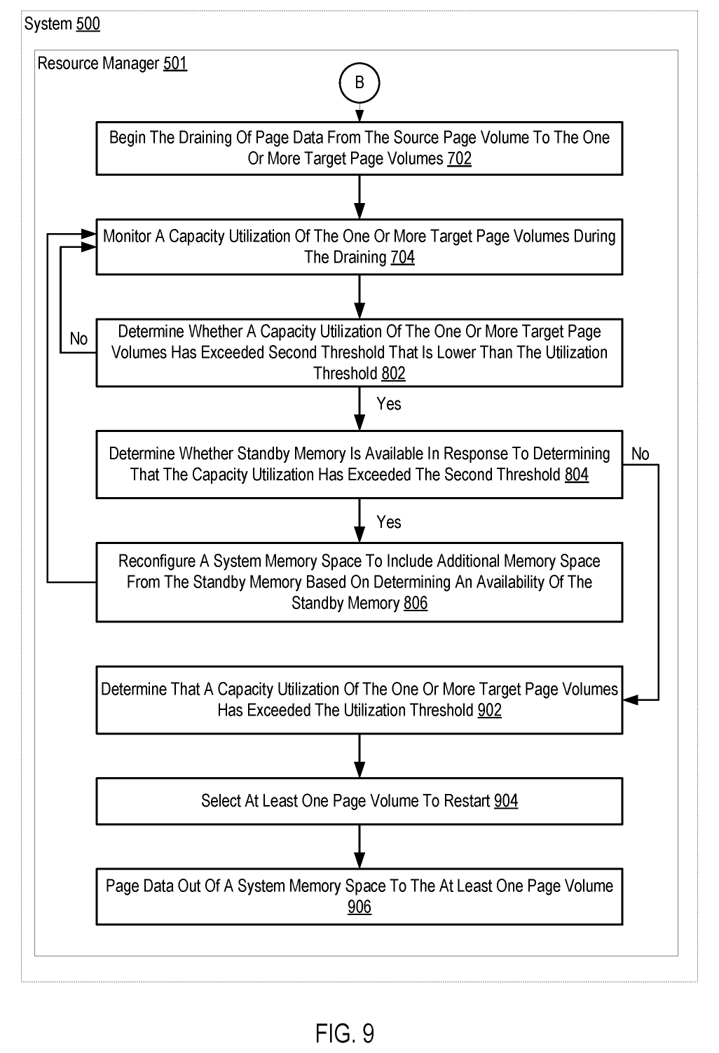

For further explanation, FIG. 9 sets forth another example method of automatic management of in-progress volume draining in accordance with one or more embodiments of the present disclosure. In some cases, system 500 may not be configured with standby memory that can be used to increase the size of the tenant’s memory space (shown by the dashed line), or system 500 may run out of standby memory that can be allocated to the tenant’s memory space for carrying out the page volume draining. In such cases, more drastic measures may be necessary to avoid the abnormal termination of executing processes due to resource exhaustion. To that end, the method of FIG. 9 extends the method of FIG. 8 in that the method of FIG. 9 also includes determining 902 that a capacity utilization of the one or more target page volumes has exceeded the utilization threshold. The resource manager 501 continues to monitor page space capacity utilization. When paging intensity does not abate and there is no additional memory that can be used to reconfigure the system memory space, it is possible that the page space capacity utilization may exceed the utilization threshold. When this happens, the resource manager 501 determines 902 that a capacity utilization of the one or more target page volumes has exceeded the utilization threshold.

The method of FIG. 9 also includes selecting 904 at least one page volume to restart. If no more resources are available to store the page data being drained from the source page volume, one or more page volumes is restarted as an active page volume to which data can be paged out of the system memory space. In some examples, the 501 selects 904 at least one page volume to restart based on a set of page volumes that have completed draining or are in the processing of draining, and the properties of those page volumes. In some examples, a particular page volume is selected from page volumes on the list of page volumes to be drained. In this case, the resource manager 501 stops the draining of the selected page volume restarts the selected page volume. In some examples, the particular page volume is selected from offline (e.g., already drained) page volumes. In systems that do not use the keep-slot feature discussed above, or where keep-slot is configured to be off, the resource manager 501 may select the page volume with the most available space (e.g., the largest capacity page volume). In systems where the keep-slot feature is enabled and pages that are paged back into physical memory are not discarded in the page volume, the resource manager 501 selects the particular page volume based a page volume score, where the page volume score is based on at least an estimated amount of page data on the particular page volume that is also present in the system memory space. In these examples, the resource manager 501 scores the page volumes that are candidates for restarting based on the amount of in-use page data or the number of in-use slots and the page volume with the highest score is selected. In some examples, the score is based on a weight total in-use space on the volume plus the total not-in-use space on the volume. The weight is a value from 0 to 1 based on a percentage of in-use space that will need new slots those pages not already having a physical slot in memory. When the keep-slot feature is enabled, when a page has been previously paged in, its slot is retained in the page volume. When a volume with in-use slots is drained and moved to physical memory, the resource manager will find that a) a given page will already resident in physical memory and does not require a new slot on another volume or b) that page is not resident in physical memory and will likely have to paged out again, thus requiring a new slot in the page volumes. Thus, the weight can be determined by monitoring activity in the physical memory address space and/or predicting that a particular page is already in physical memory or will need to be paged back out, thus requiring a new slot. As the weight approaches zero, there is a higher likelihood that a new slot will be required.

The method of FIG. 9 also includes paging 906 data out of a system memory space to the at least one page volume. In some examples, once the selected page volume has restarted, the resource manager can begin paging data out of the system memory space, including any additional memory space if allocated from standby memory. The resource manager 501 continues to monitor the capacity utilization of the page space. If the selected page volume was not sufficient to reduce capacity utilization below the utilization threshold, additional draining of offline page volumes can be selected for restarting. Once no longer needed, any additional memory space allocated from standby memory can be released back to standby memory through dynamic reconfiguration of the memory space.

In view of the foregoing, it will be appreciated that automatic management of in-progress volume draining in accordance with the present disclosure improves the operation and efficiency of a computer system by providing a mechanism to ensure that a drain of one or more page volumes can be completed without exhausting system resources. The operation and efficiency of a computer system is also improved by providing mechanisms to allocate additional memory space during the drain of one or more page volumes, thus allowing the drain to complete even in the presence of a spike in paging activity. This ensures that running processes will not abnormally terminate or stall due to a page volume drain, thus improving the availability of the computing system. The operation and efficiency of a computer system is also improved by providing mechanisms to restart page volumes that have already drained or are in the process of draining, thus increasing the capacity of the page space and alleviated the pressure on the system memory space. Optimizations are provided to select the best candidate for restarting based on page volume capacity and/or the collocation of page data on the candidate page volume and in the system memory space. Given the speed at which paging operations are carried out, an operator would not have sufficient time to realize that the page volume drain will exhaust system resources and take action to prevent the exhaustion of system resources. The above-described mechanisms, however, can prevent system resource exhaustion and prevent user processes, or the system altogether, from becoming unavailable.

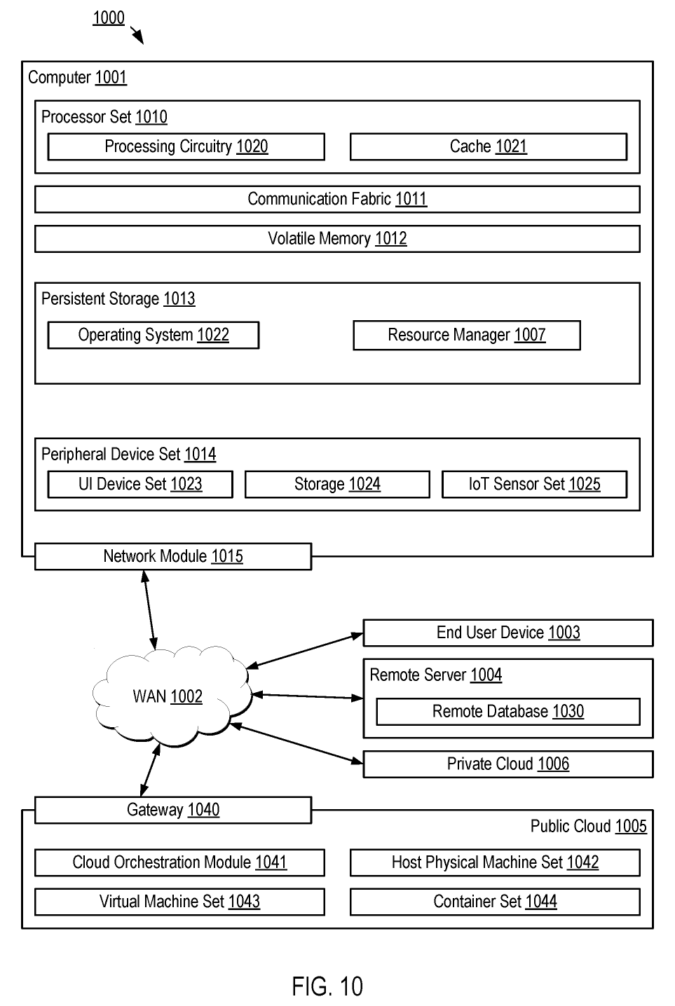

FIG. 10 sets forth an example computing environment according to aspects of the present disclosure. Computing environment 1000 contains an example of an environment for the execution of at least some of the computer code involved in performing the various methods described herein, such as resource manager code 1007. In addition to resource manager code 1007, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and resource manager code 1007, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

Computer 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

Processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 1021 and the other storage media discussed below. The program instructions, and associated data, are accessed by processor set 1010 to control and direct performance of the computer-implemented methods. In computing environment 1000, at least some of the instructions for performing the computer-implemented methods may be stored in resource manager code 1007 in persistent storage 1013.

Communication fabric 1011 is the signal conduction path that allows the various components of computer 1001 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in resource manager code 1007 typically includes at least some of the computer code involved in performing the computer-implemented methods described herein.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database), this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the computer-implemented methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a source page volume for draining to one or more target page volumes;
predicting whether at least one target page volume will exceed a utilization threshold as a result of draining page data from the source page volume to the one or more target page volumes; and
generating an alert in response to predicting that the utilization threshold will be exceeded.

2. The method of claim 1, wherein the source page volume is drained by transferring page data from the source page volume to a system memory space prior to transferring the page data to the one or more target page volumes; and
wherein the page data drained from the source page volume is marked as available for overwriting in the page volume.

3. The method of claim 2, wherein the system memory space is a logical partition of physical memory.

4. The method of claim 1 further comprising:
preserving the source page volume in response to predicting the utilization threshold will be exceeded.

5. The method of claim 1 further comprising:
beginning the draining of page data from the source page volume to the one or more target page volumes; and
monitoring a capacity utilization of the one or more target page volumes during the draining.

6. The method of claim 5 further comprising:
determining whether a capacity utilization of the one or more target page volumes has exceeded second threshold that is lower than the utilization threshold;
determining whether standby memory is available in response to determining that the capacity utilization has exceeded the second threshold; and
reconfiguring a system memory space to include additional memory space from the standby memory based on determining an availability of the standby memory.

7. The method of claim 6, wherein at least a portion of the page data is retained in the system memory space until determining that the capacity utilization is no longer above the second threshold.

8. The method of claim 5 further comprising:
determining that a capacity utilization of the one or more target page volumes has exceeded the utilization threshold;
selecting at least one page volume to restart; and
paging data out of a system memory space to the at least one page volume.

9. The method of claim 8, wherein the at least one page volume is selected from a plurality of page volumes on a list of page volumes to be drained.

10. The method of claim 8, wherein the at least one page volume is selected based on most available capacity.

11. The method of claim 8, wherein the at least one page volume is selected based a score, wherein the score of a particular page volume is based on at least an estimated amount of page data on the particular page volume that is also present in the system memory space.

12. An apparatus comprising:
a processing device; and
memory operatively coupled to the processing device, wherein the memory stores computer program instructions that, when executed, cause the processing device to:
identify a source page volume for draining to one or more target page volumes;
predict whether at least one target page volume will exceed a utilization threshold as a result of draining page data from the source page volume to the one or more target page volumes; and
generate an alert in response to predicting that the utilization threshold will be exceeded.

13. The apparatus of claim 12, wherein the memory stores computer program instructions that, when executed, cause the processing device to:
preserve the source page volume in response to predicting the utilization threshold will be exceeded.

14. The apparatus of claim 12, wherein the memory stores computer program instructions that, when executed, cause the processing device to:
begin the draining of page data from the source page volume to the one or more target page volumes; and
monitor a capacity utilization of the one or more target page volumes during the draining.

15. The apparatus of claim 14, wherein the memory stores computer program instructions that, when executed, cause the processing device to:
determine whether a capacity utilization of the one or more target page volumes has exceeded second threshold that is lower than the utilization threshold;
determine whether standby memory is available in response to determining that the capacity utilization has exceeded the second threshold; and
reconfigure a system memory space to include additional memory space from the standby memory based on determining an availability of the standby memory.

16. The apparatus of claim 14, wherein the memory stores computer program instructions that, when executed, cause the processing device to:
determine that a capacity utilization of the one or more target page volumes has exceeded the utilization threshold;
select at least one page volume to restart; and
page data out of a system memory space to the at least one page volume.

17. A computer program product comprising:
a set of one or more computer readable storage media; and
computer program instructions, collectively stored in the set of one or more storage media, that when executed, cause a processor set to perform computer operations comprising:
identifying a source page volume for draining to one or more target page volumes;
predicting whether at least one target page volume will exceed a utilization threshold as a result of draining page data from the source page volume to the one or more target page volumes; and
generating an alert in response to predicting that the utilization threshold will be exceeded.

18. The computer program product of claim 17, wherein the operations further comprise:
preserving the source page volume in response to predicting the utilization threshold will be exceeded.

19. The computer program product of claim 17, wherein the operations further comprise:
beginning the draining of page data from the source page volume to the one or more target page volumes;
monitoring a capacity utilization of the one or more target page volumes during the draining.
determining whether a capacity utilization of the one or more target page volumes has exceeded second threshold that is lower than the utilization threshold;
determining whether standby memory is available in response to determining that the capacity utilization has exceeded the second threshold; and
reconfiguring a system memory space to include additional memory space from the standby memory based on determining an availability of the standby memory.

20. The computer program product of claim 19, wherein the operations further comprise:
determining that a capacity utilization of the one or more target page volumes has exceeded the utilization threshold;
selecting at least one page volume to restart; and
paging data out of a system memory space to the at least one page volume.
